(19) United States
(12) Patent Application Publication
(10) Pub. No.: US 2004/0203603 A1
(43) Pub. Date: Oct. 14, 2004

(54) Inter-network communications with subscriber devices in wireless communications networks

(76) Inventors: William Pierce, Algonquin, IL (US); Rosemary D'Onofrio, Hawthorn Woods, IL (US); Lorne Lameer, Burlington, WI (US)

Correspondence Address: MOTOROLA INC, 600 NORTH US HIGHWAY 45, ROOM AS437, LIBERTYVILLE, IL, 60048-5343, US

(21) Appl. No.: 10/337,086

(22) Filed: Jan. 6, 2003

(51) Int. Cl. H04M 1/66; H04M 3/16

(52) U.S. Cl. 455/411; 455/456.1

(57) ABSTRACT

A mobile wireless subscriber device including a radio transceiver and methods for receiving a location information request (410) having source information, for example a network address embedded therein, determining whether the request is from an authorized source (420), sending the information requested (450), and in some embodiments first obtaining the information requested (460), if the request is from an authorized source.

### FIELD OF THE INVENTIONS

The present inventions relate generally to wireless communications, and more particularly to inter-network communications with mobile wireless subscriber devices in cellular communications networks and methods therefor.

### BACKGROUND OF THE INVENTIONS

As mobile wireless communications subscriber devices communicate increasingly with extra-cellular networks, for example, with open networks like the Internet, it is often desirable to protect the security and privacy of these communications.

Secure Socket Layer (SSL) communications are used commonly in e-commerce applications over the Internet to provide security and to protect the privacy of user and transactional information. A Secured Socket Layer however increases communications overhead, by as much as 20 percent, and introduces delay, which may be undesirable for some applications. These and other considerations suggest that subscriber devices would benefit from alternative schemes for securing communications made from private communications network to other networks.

The various aspects, features and advantages of the present inventions will become more fully apparent to those having ordinary skill in the arts upon careful consideration of the following Detailed Description of the Invention with the accompanying drawings described below.

### BRIEF DESCRIPTION OF THE DRAWINGS

FIG. 1 is an exemplary mobile wireless subscriber device that communicates with a network beyond a cellular communications network.

FIG. 2 is a wireless subscriber device schematic block diagram according to an exemplary embodiment of the invention.

FIG. 3 is an exemplary process flow diagram for processing an extra-cellular information request.

FIG. 4 is another exemplary process flow diagram for processing an information request.

### DETAILED DESCRIPTION OF THE INVENTIONS

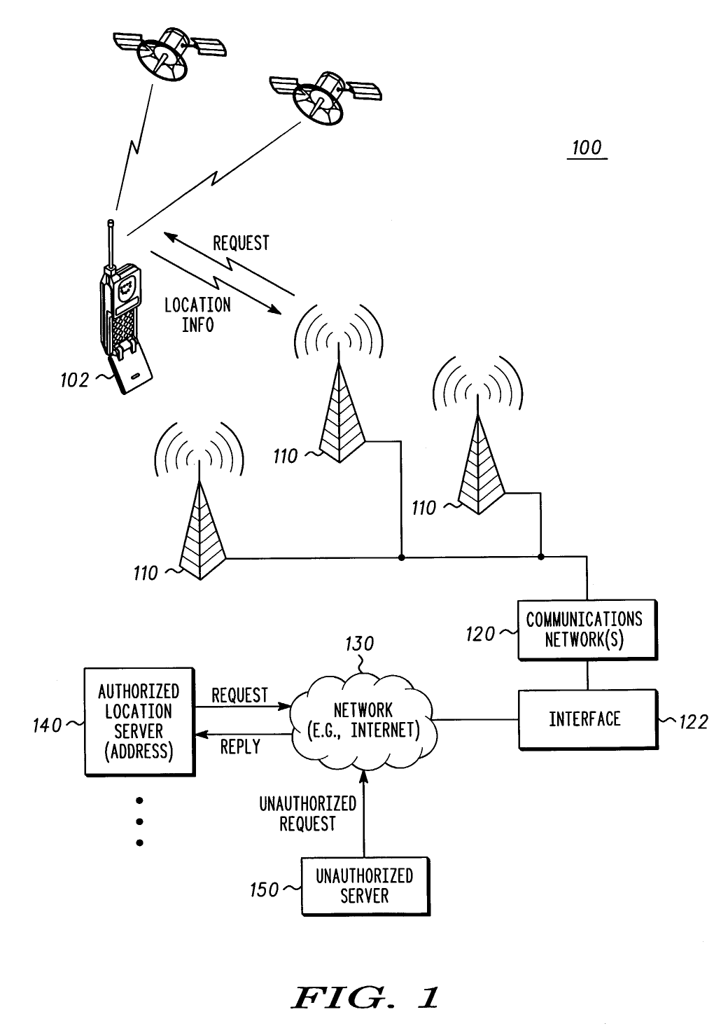

FIG. 1 is an exemplary system of networks 100 including a cellular communications network supporting communications of mobile wireless communications devices, for example, subscriber device 102, capable of communicating within the cellular network and with extra-cellular networks, for example, the Internet and other networks outside the cellular network.

The exemplary cellular communications network comprises generally a plurality of base station transceivers 110 connected to communications network infrastructure known generally and designated at block 120. The cellular communications network may be a 2.5 Generation (2.5G) Global System for Mobile Communications/Enhanced Data rates for GSM Evolution (GSM/EDGE) Radio Access Network (GERAN), or a 3^{rd} Generation (3G) Universal Terrestrial Radio Access Network (UTRAN), or a combination of 2.5G and 3G networks, or some other communication network or networks. The infrastructure and operation of these and other communications networks is known generally and therefore not discussed further herein, except as required for understanding the instant invention.

In FIG. 1, the communications network is coupled to another network 130, for example, an open network like the Internet, among other networks, which may be private or open. The communications network is generally coupled to the external network by a network interface 122, which is, for example, a gateway mobile location center (GMLC), or a gateway GPRS support node (GGSN), or some other network interface.

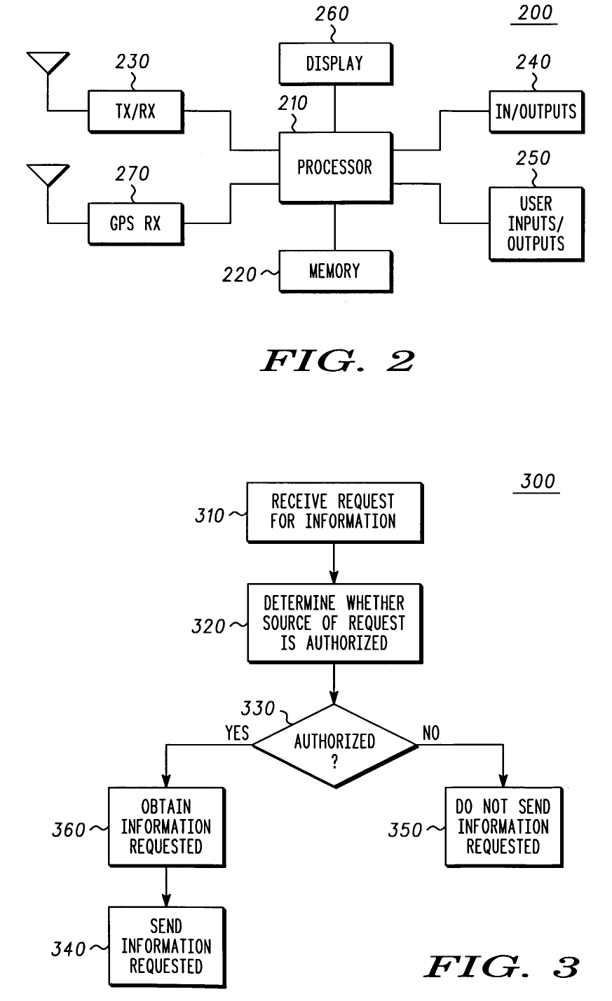

FIG. 2 is an exemplary wireless subscriber device architecture 200 comprising generally a processor 210 coupled to memory 220, which may include ROM, RAM, EPROM and other storage media. The exemplary device also includes a radio transceiver 230 for communicating pursuant to a radio communications protocol or standard supported by the radio communications network. The exemplary device also includes input and outputs 240, for example auxiliary power, data ports, other signal ports, etc. The user inputs and outputs 250 include a keypad and possibly other input devices, a microphone, an audio speaker, etc. The device also includes a display 260, and in some forms may include a satellite positioning system receiver, for example, a GPS receiver 270. The subscriber device may be a cellular telephone, or a two-way pager device, or a communications enabled personal digital assistant (PDA) or notebook computer or some other mobile communications subscriber device.

Communications of mobile wireless communications subscriber devices beyond the cellular communications network, for example, with the Internet, may in some instance be susceptible to breaches of security and privacy. In FIG. 1, for example, mobile subscriber devices running location-based applications may receive requests for location information from one or more location server 140 outside the cellular communications network. Other non-cellular network servers may request other types of information, for example, financial information required in e-commerce sales transactions, which is generally the subject of desires for privacy and security. Occasionally, however, a request for information from a subscriber device may come from an unauthorized source, like a hacker, communicating via unauthorized server, for example, from server 150 in FIG. 1.

In the process flow diagram of FIG. 3, at block 310, the subscriber device receives a request for information from an extra-cellular network source via the cellular communications network. The request may be in the exemplary form of an Internet Protocol (IP) message from a Push Proxy Gateway (PPG). Alternatively, the request may be in the exemplary form of a Short Message Service (SMS) message from an SMS Center (SMSC), or in the form of some other message request.

At block 320, a determination is made as to whether the source of the request is authorized to receive the information requested. In one embodiment, the authorization determination is made at the subscriber device, although in other embodiments the authorization determination may be made at the cellular network, for example, at a firewall or at some other network-based entity.

Generally, the source of the information request has a unique identity, for example, a telephone number or a network address, etc. In the exemplary architecture of FIG. 1, a location server 140 coupled to the network 130 having a network address, for example, an IP address, an X.25 address, an X.400 address, an SS7 point code, among others, sends a request for location information to the subscriber device 102 via the network 130 and cellular communications network base station 110.

In one embodiment, the determination of whether the source requesting information from the subscriber device is authorized to receive information form the subscriber device includes determining whether the network address of the source is on a list of at least one authorized or approved network address. The determination may be made by comparing the network address of the source to the list of approved or authorized network addresses. The comparison may be performed at the cellular network or preferably in the subscriber device.

In embodiments where the authorization determination is made at the subscriber device, the authorized network address list is stored on the subscriber device, for example, in memory 220 illustrated in FIG. 2. The subscriber device may be provisioned with the authorized address list using a variety of methods, including, for example, flashing into memory, or by flexing at the factory or at a point-of-sale with RS232, USB, IEEE488, etc. interface. The list may also be transmitted to the device via secure over-the-air provisioning, manual input by the user, etc., thereby permitting updating of the authorized list.

The subscriber device or network entity also includes software, which is also stored in memory, for performing the authorization determination. More particularly, the software reads or extracts the network address embedded in the request and compares it to the one or more authorized addresses of the list.

In FIG. 3, at block 340, the information requested is provided to the requesting source, only if the address of the requester is authorized, at decisional block 330, to receive the information requested. In embodiments where authorization determination is made at the cellular network, the cellular network may dispatch the message to the subscriber device only if the address of the requestor is authorized to receive the information requested, whereupon the subscriber device provides the information requested to the source. If the source is not authorized to receive information, then it is not provided, as indicated at block 350. This functionality is also preferably controlled by software.

In some embodiments, the subscriber device must obtain the information requested by the source in response to the request, or the information requested requires some input or action by the user. In some embodiments, the requested information is obtained only after determining that the source of the request is authorized to receive the information, as illustrated at block 360 of FIG. 3.

For example, a request for location information may require that the subscriber device compute a location fix, for example, using the on-board GPS receiver or some other technique, like enhance observed time of arrival (E-OTD). Alternatively, the location fix may be obtained from the network. Generally, obtaining the information requested requires the expenditure of power or some other resource, which may be avoided if a determination is first made that the requester is not authorized.

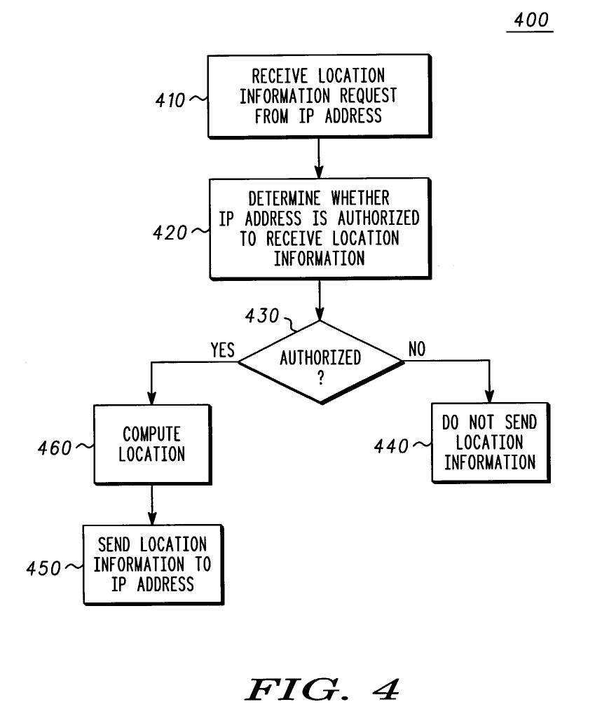

In the exemplary process 400 of FIG. 4, at block 410, the subscriber device receives a request for location information from a source having an IP or other network address. At block 420, the subscriber device determines whether the request is from an authorized source by determining whether the network address of the source is an authorized address.

At decisional block 430, if the source is not authorized, the location information is not provided to the requester, as indicated at block 440. If the source is authorized, the location information is provided to the requester, as indicated at block 450. As suggested, in embodiments where location information is requested, it may be necessary for the subscriber device to obtain, for example compute or request, a new or updated location fix. In some embodiments, the location information is obtained after a positive authorization determination is made, and other embodiments the location information is obtained concurrently during the authorization determination.

While the present inventions and what are considered presently to be the best modes thereof have been described sufficiently to establish possession by the inventors and to enable those of ordinary skill to make and use the inventions, it will be understood and appreciated that there are equivalents to the exemplary embodiments disclosed herein and that many modifications and variations may be made thereto without departing from the scope and spirit of the inventions, which are to be limited not by the exemplary embodiments but by the claims appended hereto.

What is claimed is:

1. A method in a mobile wireless communication device having location information, the method comprising:
receiving a request for location information from a source having a network address;
determining whether the source is authorized to receive location information of the mobile wireless communication device;
sending location information to the network address only if the source is authorized to receive location information.

2. The method of claim 1,
determining a location of the mobile wireless communication device after receiving the request for location information only if the source is authorized to receive the location information,
sending location information by sending a location of the mobile wireless communication device determined after receiving the request.

3. The method of claim 1, determining whether the source is authorized to receive location information of the mobile wireless communication device includes determining whether the network address of the source is authorized to receive location information of the mobile wireless communication device.

4. The method of claim 1,
determining whether the source is authorized to receive location information of the mobile wireless communication device includes comparing the network address of the source with at least one authorized network address.

5. The method of claim 1,
determining whether the source is authorized to receive location information of the mobile wireless communication device includes comparing the network address of the source with a list of at least one authorized network address stored on the mobile wireless communication device.

6. The method of claim 1,
determining a location of the mobile wireless communication device after receiving the request for location information,
sending location information by sending a location of the mobile wireless communication device, determined after receiving the request, only if the source is authorized to receive the location information.

7. A method in a mobile wireless cellular communication system, the method comprising:
receiving a request for information from a mobile wireless communication device from an extra-cellular network;
obtaining the information requested after receiving the request for information;
determining whether a source of the request is authorized to receive the information requested from the mobile wireless communication device;
sending the information requested to the source in response to the request only if the source is authorized to receive information.

8. The method of claim 7,
obtaining the information requested only if the source is authorized to receive the information.

9. The method of claim 7, determining whether the source is authorized to receive information at a cellular network of the cellular communication system.

10. The method of claim 9,
obtaining the information requested only if the source is authorized to receive the information.

11. The method of claim 7,
receiving the request for information from a source having a network address,
determining whether the source is authorized to receive information at the mobile wireless subscriber device,
obtaining the information requested only if the source is authorized to receive the information.

12. The method of claim 10,
determining whether the source is authorized to receive information includes determining whether the network address of the source is on a list of network addresses stored on the mobile wireless communication device.

13. The method of claim 7, determining whether the source of the request is authorized to receive information from the mobile wireless communication device by comparing the source to at least one approved source at the mobile wireless communication device.

14. A mobile wireless subscriber device, comprising:
a processor coupled to memory;
authorized source information stored in memory;
a radio transceiver for receiving a location information request having source information;
the processor for determining whether the request is from an authorized source by comparing the source information of the request and the authorized source information stored in memory.

15. The mobile wireless subscriber device of claim 14, the processor for obtaining location information in response to the request for location information only if the request is from an authorized source.

16. The mobile wireless subscriber device of claim 14, a satellite positioning system receiver for obtaining location information in response to the request for location information only if the request is from an authorized source.

17. The mobile wireless subscriber device of claim 14, the transceiver for transmitting location information in response to the request only if the request is from an authorized source.

18. A mobile wireless subscriber device, comprising:
a processor coupled to memory;
authorized address information stored in memory;
a radio transceiver for receiving an information request having address information;
the processor for determining whether the request is from an authorized source by comparing the address information of the request and the authorized address information stored in memory;
the processor for obtaining the information requested only if the request is from an authorized source.

19. The mobile wireless subscriber device of claim 18, the transceiver for transmitting information in response to the request only if the request is from an authorized source.
